(19) United States
(12) Patent Application Publication
(10) Pub. No.: US 2009/0156391 A1
(43) Pub. Date: Jun. 18, 2009

(54) Catalyst Components for the Polymerization of Olefins

(75) Inventors: Dario Liguori, Forino (IT); Francesca Focante, Filottrano (IT); Giampiero Morini, Padova (IT); Luigi Resconi, Ferrara (IT); Gianni Vitale, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l., Milan (IT)

(21) Appl. No.: 12/086,070

(22) PCT Filed: Nov. 29, 2006
(86) PCT No.: PCT/EP2006/069031

§ 371 Date: Jun. 5, 2008

Related U.S. Application Data
(60) Provisional application No. 60/749,790, filed on Dec. 13, 2005.

(30) Foreign Application Priority Data
Dec. 6, 2005 (EP) 05111740.6

(51) Int. Cl. C08F 4/64

(52) U.S. Cl. 502/103

(57) ABSTRACT

A catalyst component for the polymerization of olefins CH₂═CHR, wherein R is hydrogen or a hydrocarbon radical having 1-12 carbon atoms. In particular, the present invention relates to catalyst components comprising Mg, Ti, halogen and a compound selected from phosphorous derivatives, boron derivatives and aromatic heterocyclic nitrogen derivatives. Said catalyst components are particularly suitable for the preparation of homo and copolymers of ethylene with α-olefins.

This application is the U.S. national phase of International Application Number PCT/EP2006/069031, filed Nov. 29, 2006, claiming priority to European Patent Application 05111740.6 filed Dec. 6, 2005, and the benefit under 35 U.S.C. 119(e) of U.S. Provisional Application No. 60/749,790, filed Dec. 13, 2005; the disclosures of International Application Number PCT/EP2006/069031, European Patent Application 05111740.6 and U.S. Provisional Application No. 60/749,790, each as filed, are incorporated herein by reference.

The present invention relates to catalyst components for the polymerization of olefins CH₂═CHR, wherein R is hydrogen or a hydrocarbon radical having 1-12 carbon atoms. In particular, the present invention relates to catalyst components comprising Mg, Ti, halogen and a compound selected from phosphorous derivatives, boron derivatives and aromatic heterocyclic nitrogen derivatives. These catalyst components, when converted into a catalyst, are particularly suitable for the preparation of homo and copolymers of ethylene with α-olefins. Accordingly, another object of the present invention is the use of said catalysts in a process for the copolymerization of olefins in order to produce said ethylene homo and copolymers.

Linear low-density polyethylene (LLDPE) is one of the most important families of products in the polyolefin field. The family comprises ethylene/α-olefin copolymers containing an amount of α-olefin deriving units such as to have products with a density in the range 0.925-0.88. Due to their characteristics, these copolymers find application in many sectors and in particular in the field of wrapping and packaging of goods where, for example, the use of stretchable films based on LLDPE constitutes an application of significant commercial importance. LLDPE is commercially produced with liquid phase processes (solution or slurry) or via the more economical gas-phase process. Both processes involve the widespread use of Ziegler-Natta MgCl₂-supported catalysts that are generally formed by the reaction of a solid catalyst component, in which a titanium compound is supported on a magnesium halide, with a suitable activator usually an alkylaluminium compound.

As far as the preparation of LLDPE is concerned, said catalysts are required to show good comonomer distribution suitably coupled with high yields.

The homogeneous distribution of the comonomer (α-olefin) in and among the polymer chains is very important. In fact, having a comonomer randomly or alternatively distributed along the polymer chain and, at the same time, having the polymer fractions with a similar average content of comonomer (narrow distribution of composition) allows the achievement of high quality ethylene copolymers. These latter usually combine, at the same time, a density sufficiently lower with respect to HDPE and a low content of polymer fractions soluble in hydrocarbon solvents like hexane or xylene which worsen certain properties of the said copolymers.

In view of the above, it would be very important for the catalysts to be used in LLDPE preparation to show a good ability to homogeneously distribute the comonomer as explained above. As the above-mentioned heterogeneous Ziegler-Natta catalysts generally are not particularly satisfactory in doing so, the general attempt is that of trying to improve this characteristic by using the so-called electron donor compounds.

U.S. Pat. No. 4,142,532 discloses catalyst components for the polymerization of olefins obtained by metal complexes of formula MgₘTiCl₂ₘY.nE in which Y is one atom or group of atoms satisfying the valence of Ti and E is an electron donor compound. Specific examples of these complexes are for example those obtained by the reaction of TiCl₃ with MgCl₂ and electron donors such as ethyl acetate, ethanol, or tetrahydrofurane. In the said document these catalyst components have never been used for the copolymerization of olefins but only in the homopolymerization process. Moreover, from the figures reported it is possible to see that the specific activities (KgPE/gcat·atm·h) are very low.

In EP 1058696 is disclosed a catalyst component for the preparation of ethylene homo and copolymers comprising (a) impregnating particulate inorganic oxide support with at least one organomagnesium compound to form a first reaction product; (b) halogenating the first reaction product to convert the organomagnesium compound into a magnesium halide, thereby forming a second reaction product; (c) treating the second reaction product with a group 4 or 5 transition metal compound, at least one alkyl di or tri-substituted pyridine electron donor and at least one group 2 or 13 organometal compound. The so obtained catalyst displays a low activity in the preparation of ethylene homopolymer which is not particularly high and causes a narrowing of the molecular weight distribution of the polymer. The narrowing is undesired for certain application such as high-speed extrusion and blow molding, in which the narrow MWD could cause melt fracture.

It is therefore felt the need of a versatile catalyst component displaying both ability to give a homogeneous comonomer distribution in the preparation of ethylene copolymers and high polymerization activity while not displaying substantial variation in the molecular weight distribution in the production of ethylene homopolymer.

The applicant has now found a catalyst component for olefin polymerization able to satisfying the above needs, which comprises Mg, Ti, halogen and at least one compound belonging to at least one of (a) aromatic heterocyclic nitrogen derivatives in which at least one nitrogen atom is part of a five member ring structure, (b) boron derivatives of formula BR₃, and (c) phosphorous derivatives of formula PR₃ or POR₃, in which R is, independently, halogen, a hydrocarbyl group having from 1 to 20 carbon atoms or a hydrocarbyloxy group having up to 20 carbon atoms. The above-mentioned compounds can also be used in mixture with each other or with different electron donor compounds such as alcohols, anhydrides etc.

Preferred aromatic heterocyclic nitrogen derivatives according to (a) comprise both compounds with only the five member ring such as pyrrole derivatives and those having such five member ring condensed with other rings such as indole derivatives. Both the single ring and the condensed ring structures may bring additional substituents preferably selected C1-C10 alkyl, alkenyl, or aryl groups. Preferred aromatic heterocyclic nitrogen derivatives according to (a) are pyrrole, 1-methylpyrrole, 1-ethyl pyrrole, indole, 1-methyl indole, 1-ethyl indole, pyrazole, imidazole, indazole, benzimidazole, benzotriazole.

Preferred boron derivatives (b) of formula BR₃ are those in which R is selected from chlorine or hydrocarbyloxy group having up to 20 carbon atoms, in particular alkoxy groups having from 1 to 10 carbon atoms. Among them, preferred boron derivatives are BCl₃, B(OMe)₃, B(OEt)₃, B(Oi-Pr)₃, B(OBu)₃ and B(C₆F₅)₃.

Preferred phosphorous derivatives (c) of formula PR₃ or POR₃ are those in which R is selected from chlorine, hydrocarbyloxy group having up to 10 carbon atoms or alkyl groups having up to 10 carbon atoms. Particularly preferred are the compounds in which R is chlorine or a C1-C10 alkoxy group such as PCl₃, POCl₃, P(OMe)₃, P(OEt)₃.

The Mg/Ti molar ratio ranges preferably from 1 to 50 preferably from 1 to 20 and more preferably from 4 to 20.

In a particular embodiment of the present invention, the catalyst component comprises, in addition to the compound belonging to at least one of (a), (b) and/or (c), a Ti compound and a magnesium dihalide Preferred titanium compounds are the tetrahalides or the compounds of formula TiXₙ(OR¹)₄₋ₙ, where 0≦n≦3, X is halogen, preferably chlorine, and R¹ is C₁-C₁₀ hydrocarbon group. Titanium tetrachloride is the preferred compound.

The magnesium dihalide is preferably MgCl₂ in active form which is widely known from the patent literature as a support for Ziegler-Natta catalysts. U.S. Pat. No. 4,298,718 and U.S. Pat. No. 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra in which the most intense diffraction line that appears in the ASTM-card reference of the spectrum of the non-active halide is diminished in intensity and broadened. In the X-ray spectra of preferred magnesium dihalides in active form said most intense line is diminished in intensity and replaced by a halo whose maximum intensity is displaced towards lower angles relative to that of the most intense line.

The catalyst components of the invention can be prepared according to several methods. According to one of these methods, the magnesium dichloride in an anhydrous state and the suitable amount of the compound belonging to at least one of (a), (b) or (c) are milled together under conditions in which activation of the magnesium dichloride occurs. The so obtained product can be treated one or more times with a suitable amount of TiCl₄. This treatment is followed by washings with hydrocarbon solvents until chloride ions disappeared.

According to a particular embodiment, the solid catalyst component can be prepared by reacting a suitable amount titanium compound of formula Ti(OR¹)_{n-y}X_{y}, where n is the valence of titanium and y is a number between 1 and n, preferably TiCl₄, with a magnesium chloride deriving from an adduct of formula MgCl₂.pR²OH, where p is a number between 0.1 and 6, preferably from 2 to 4.5, and R² is a hydrocarbon radical having 1-18 carbon atoms, in the presence of the compound belonging to at least one of (a), (b) and/or (c). The adduct can be suitably prepared in spherical form by mixing alcohol and magnesium chloride in the presence of an inert hydrocarbon immiscible with the adduct, operating under stirring conditions at the melting temperature of the adduct. Then, the emulsion is quickly quenched, thereby causing the solidification of the adduct in form of spherical particles. A particularly suitable method for preparing the catalyst according to the invention, particularly suitable for the gas-phase polymerization, comprises the following steps:

(i) reacting a compound MgCl₂.mR³OH, wherein 0.3≦m≦2.3 and R³ is an alkyl, cycloalkyl or aryl radical having 1-12 carbon atoms, with a titanium compound of the formula Ti(OR¹)ₙX_{y-n}, in which n is comprised between 0 and 0.5, y is the valence of titanium, X is halogen and R is an alkyl radical having 2-8 carbon atoms or a COR group and (ii) contacting the compound (a) or (b) or (c) or mixtures thereof with the product of the previous step. The adduct MgCl₂.mR³OH can be prepared by thermal dealcoholation of adducts MgCl₂.pEtOH, wherein p is equal to or higher than 2 and preferably ranging from 2.5 to 4.5. Said adducts, in spherical form, can be prepared from molten adducts by emulsifying them in liquid hydrocarbon and thereafter solidifying them by quick cooling. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034. As mentioned above the so obtained adducts are subjected to thermal dealcoholation at temperatures comprised between 50 and 150° C. until the alcohol content is reduced to values lower than 2.5 and preferably comprised between 1.7 and 0.3 moles per mole of magnesium dichloride.

The dealcoholation can also be carried out chemically by using any chemical agent having functionalities capable to react with the OH groups. A particularly preferred group of dealcoholating agents is that of alkyl aluminum compounds. Particularly preferred is the use of the trialkyl aluminum compounds such as for example triethylaluminum, triisobutylaluminum, tri-n-butylaluminum, tri-n-hexylaluminum, tri-n-octylaluminum and tris(2,4,4-trimethyl-pentyl)aluminum. Use of triethylaluminum is especially preferred. It is also possible to use mixtures of trialkylaluminum compounds with alkylaluminum halides, alkylaluminum hydrides or alkylaluminum sesquichlorides, such as AlEt₂Cl and Al₂Et₃Cl₃.

Another group of usable dealcoholating agent is that of halogen-containing silicon compounds. Specific examples of such silicon compounds include the silicon halides having formula SiX₄₋ₙ, in which X and Y represent halogen atoms, e.g., Cl and Br, and n is a number varying from zero to 3. The use of SiCl₄ is particularly preferred.

The step (i) of reaction with the Ti compound can be carried out for example by suspending the adduct in TiCl₄ (generally cold) the mixture is heated up to temperatures ranging from 80-130° C. and kept at this temperature for 0.5-2 hours. The treatment with the titanium compound can be carried out one or more times. Preferably it is repeated twice. It can also be carried out in the presence of an electron donor compound as those mentioned above. At the end of the process the solid is recovered by separation of the suspension via the conventional methods (such as settling and removing of the liquid, filtration, and centrifugation) and can be subject to washings with solvents. Although the washings are typically carried out with inert hydrocarbon liquids, it is also possible to use more polar solvents (having for example a higher dielectric constant) such as halogenated hydrocarbons.

The so obtained solid intermediate can also undergo a post-treatment with particular compounds suitable to impart to it specific properties. As an example, it can be subject to a treatment with a reducing compound for example an Al-alkyl compound, in order to lower the oxidation state of the titanium compound contained in the solid.

Another example of treatment that can be carried out on the intermediate is a pre-polymerization step. The pre-polymerization can be carried out with any of the olefins CH₂═CHR¹, where R¹ is H or a C1-C10 hydrocarbon group. In particular, it is especially preferred to pre-polymerize ethylene or propylene or mixtures thereof with one or more α-olefins, said mixtures containing up to 20% in moles of α-olefin, forming amounts of polymer from about 0.1 g up to about 1000 g per gram of solid intermediate, preferably from about 0.5 to about 500 g per gram per gram of solid intermediate. The pre-polymerization step can be carried out at temperatures from 0 to 80° C., preferably from 5 to 70° C., in the liquid or gas phase. The pre-polymerization of the intermediate with ethylene or propylene in order to produce an amount of polymer ranging from 0.5 to 20 g per gram of intermediate is particularly preferred. The pre-polymerization is carried out with the use of a suitable cocatalyst such as organoaluminum compounds that can also be used in combination with one or more external donors that are below discussed in detail.

As mentioned above, the product coming from step (i) is then brought into contact, in step (ii) with the compound belonging to at least one of (a) or (b) and/or (c). The amount of such compound(s) used in step (ii) can widely vary. As an example, it can be used in molar ratio with respect to the Ti content in the product coming from (i) ranging from 0.5 to 20 and preferably from 1 to 10. Although not strictly required the contact is typically carried out in a liquid medium such as a liquid hydrocarbon. The temperature at which the contact takes place can vary depending on the nature of the reagents. Generally it is comprised in the range from −10° to 150° C. and preferably from 0° to 120° C. It is within the ordinary knowledge for the skilled in the art to avoid temperatures causing the decomposition or degradation of any specific reagents should be avoided even if they fall within the generally suitable range. Also the time of the treatment can vary in dependence of other conditions such as nature of the reagents, temperature, concentration etc. As a general indication this contact step can last from 10 minutes to 10 hours more frequently from 0.5 to 5 hours. If desired, in order to further increase the final donor content, this step can be repeated one or more times. At the end of this step the solid is recovered by separation of the suspension via the conventional methods (such as settling and removing of the liquid, filtration, and centrifugation) and can be subject to washings with solvents. Although the washings are typically carried out with inert hydrocarbon liquids, it is also possible to use more polar solvents (having for example a higher dielectric constant) such as halogenated or oxygenated hydrocarbons.

Also in this case the so obtained solid can undergo a post-treatment with particular compounds suitable to impart to it specific properties. As an example, it can be subject to a treatment with a reducing compound for example an Al-alkyl compound, in order to lower the oxidation state of the titanium compound contained in the solid.

The solid catalyst components according to the present invention are converted into catalysts for the polymerization of olefins by reacting them with organoaluminum compounds according to known methods.

In particular, it is an object of the present invention a catalyst for the polymerization of olefins CH₂═CHR, in which R is hydrogen or a hydrocarbyl radical with 1-12 carbon atoms, comprising the product of the reaction between:

1) a solid catalyst component as described above,
2) an alkylaluminum compound and, optionally,
3) an external electron donor compound.

The alkyl-Al compound can be preferably selected from the trialkyl aluminum compounds such as for example trimethylaluminum (TMA), triethylaluminum (TEAL), triisobutylaluminum (TIBA)), tri-n-butylaluminum, tri-n-hexylaluminum, tri-n-octylaluminum. Also alkylaluminum halides and in particular alkylaluminum chlorides such as diethylaluminum chloride (DEAC), diisobutylalumunum chloride, Al-sesquichloride and dimethylaluminum chloride (DMAC) can be used. It is also possible to use, and in certain cases preferred, mixtures of trialkylaluminum's with alkylaluminum halides. Among them mixtures between TEAL and DEAC are particularly preferred. The use of TIBA, alone or in mixture is also preferred. Particularly preferred is also the use of TMA.

The external electron donor compound can be equal to or different from the compound (a), (b) or (c) used in the solid catalyst component. Preferably it is selected from the group consisting of ethers, esters, amines, ketones, nitriles, silanes and mixtures of the above. In particular it can advantageously be selected from the C2-C20 aliphatic ethers and in particulars cyclic ethers preferably having 3-5 carbon atoms cyclic ethers such as tetrahydrofurane, dioxane. In addition, the electron donor compound can also be advantageously selected from silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. Particularly preferred are the silicon compounds in which a is 0, c is 3, R⁶ is a branched alkyl or cycloalkyl group, optionally containing heteroatoms, and R⁷ is methyl. Examples of such preferred silicon compounds are cyclohexyltrimethoxysilane, t-butyltrimethoxysilane and thexyltrimethoxysilane.

The above mentioned components (1)-(3) can be fed separately into the reactor where, under the polymerization conditions can exploit their activity. It constitutes however a particular advantageous embodiment the pre-contact of the above components, optionally in the presence of small amounts of olefins, for a period of time ranging from 0.1 to 120 minutes preferably in the range from 1 to 60 minutes. The pre-contact can be carried out in a liquid diluent at a temperature ranging from 0 to 90° C. preferably in the range of 20 to 70° C.

The so formed catalyst system can be used directly in the main polymerization process or alternatively, it can be pre-polymerized beforehand. A pre-polymerization step is usually preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene or mixtures thereof with one or more α-olefins, said mixtures containing up to 20% in moles of α-olefin, forming amounts of polymer from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred.

In particular, the catalyst components of the invention are able to give ethylene homopolymer (high density ethylene homopolymer HDPE with density higher than 0.95 g/cm³) in high yield, high bulk density and with a medium-broad molecular weight distribution evidenced by a Melt Flow Ratio (ratio between Melt Index measured at 190° C. according to ASTM D-1238 “F” (load of 21.6 Kg) and that at condition “E” (load of 2.16 Kg). When used in the copolymerization of ethylene with α-olefins having from 3 to 12 carbon atoms, having a mole content of units derived from ethylene of higher than 80%. (low density polyethylenes—LLDPE—having a density lower than 0.940 g/cm³, and very-low-density and ultra-low-density polyethylenes—VLDPE and ULDPE, having a density lower than 0.920 g/cm³ to 0.880 g/cm³) the catalysts of the invention are able to homogeneously distribute the comonomer in and among the polymer chains. As shown in the examples below, said copolymers in fact are generally characterized by low amount of xylene soluble fraction in respect of the extent of comonomer incorporation and density. In many cases, particularly when an external donor is used, the comonomer is also well distributed in and among the chain as shown by the substantial lowering of the density even in respect of relatively minor amount of comonomer introduced.

The following examples are given in order to further describe the present invention in a non-limiting manner.

### Characterization

The properties are determined according to the following methods:

Melt Index: measured at 190° C. according to ASTM D-1238 condition “E” (load of 2.16 Kg) and “F” (load of 21.6 Kg);
Fraction soluble in xylene. The solubility in xylene at 25° C. was determined according to the following method: About 2.5 g of polymer and 250 mL of o-xylene were placed in a round-bottomed flask provided with cooler and a reflux condenser and kept under nitrogen. The mixture obtained was heated to 135° C. and was kept under stirring for about 60 minutes. The final solution was allowed to cool to 25° C. under continuous stirring, and was then filtered. The filtrate was then evaporated in a nitrogen flow at 140° C. to reach a constant weight. The content of said xylene-soluble fraction is expressed as a percentage of the original 2.5 grams.

### Comonomer Content

1-Butene was determined via Infrared Spectrometry.

The α-olefins higher than 1-butene were determined via Infra-Red analysis.

Effective density: ASTM-D 1505
Thermal analysis: Calorimetric measurements were performed by using a differential scanning calorimeter DSC Perkin-Elmer. The instrument is calibrated with indium and tin standards. The weighted sample (5-10 mg), obtained from the Melt Index determination, was sealed into aluminum pans, thermostatted at 5° C. for 3 minutes, heated to 200° C. at 20° C./min and kept at that temperature for a time long enough (5 minutes) to allow a complete melting of all the crystallites. Successively, after cooling at 20° C./min to −20° C., the peak temperature was assumed as crystallization temperature (Tc). After standing 5 minutes at 0° C., the sample was heated to 200° C. at a rate of 20° C./min. In this second heating run, the peak temperature was assumed as melting temperature (Tm) and the area as the global melting enthalpy (ΔH).

Determination of Mg, Ti: has been carried out via inductively coupled plasma emission spectroscopy (ICP).

Determination of Cl: has been carried out via potentiometric titration.

### EXAMPLES

### General Procedure for the Preparation of the Solid Catalyst Component

### Preparation of the Spherical Support (Adduct MgCl₂/EtOH)

A magnesium chloride and alcohol adduct containing about 3 mols of alcohol was prepared following the method described in example 1 of U.S. Pat. No. 4,399,054, but working at 2000 RPM instead of 10000 RPM.

The so obtained spherical support, prepared according to the general method underwent a thermal treatment, under N₂ stream, over a temperature range of 50-150° C. until spherical particles having a residual ethanol content of about 25% (1.1 mole of ethanol for each MgCl₂ mole) were obtained.

Into a 500 mL four-necked round flask, purged with nitrogen, 250 mL of TiCl₄ were introduced at 0° C. Then, at the same temperature, 17.5 g of a spherical MgCl₂/EtOH adduct containing 25% wt of ethanol and prepared as described above were added under stirring. The temperature was raised to 130° C. in 1 h and maintained for 60 min. Then, the stirring was discontinued, the solid product was allowed to settle and the supernatant liquid was siphoned off.

The solid was washed six times with anhydrous hexane (5×100 mL) at 60° C. and once at 25° C. Finally, the solid was dried under vacuum.

In a 500 mL four-necked round flask equipped with a mechanical stirrer and purged with nitrogen, 200 mL of anhydrous hexane and 10 g of the solid intermediate component obtained as disclosed above were charged at room temperature. At the same temperature, under stirring was added dropwise (for those that are solid at room temperature an hexane solution was prepared) the desired compound (a), or (b) or (c) according to the invention, in an amount indicated such as to give a molar ratio of 4 with respect to the Ti content in the intermediate component. The temperature was raised to 50° C. and the mixture was stirred for 2 hours. Then, the stirring was discontinued, the solid product was allowed to settle and the supernatant liquid was siphoned off.

The solid was washed 5 times with anhydrous hexane (3×100 mL) at 25° C., recovered, dried under vacuum and analyzed.

Ethylene/α-olefin Copolymerization: General Procedure

A 4.5 liter stainless-steel autoclave equipped with a magnetic stirrer, temperature and pressure indicators, feeding line for ethylene, propane, 1-butene, hydrogen, and a steel vial for the injection of the catalyst, was purified by fluxing pure nitrogen at 70° C. for 60 minutes. It was then washed with propane, heated to 75° C. and finally loaded with 800 g of propane, 1-butene (amount as reported in table 1), ethylene (7.0 bar, partial pressure) and hydrogen (1.5 bar).

In a 100 cm³ three neck glass flask were introduced in the following order, 50 cm³ of anhydrous hexane, 9.6 cm³ of 10% by wt/vol TEA/DEAC (2:1 molar)/hexane solution, Tetrahydrofurane as external electron donor compound (Al/THF molar ratio 5) and the solid catalyst of example. They were mixed together and stirred at room temperature for 5 minutes and then introduced in the reactor through the steel vial by using a nitrogen overpressure.

Under continuous stirring, the total pressure was maintained constant at 75° C. for the time reported in table 1 by feeding ethylene. At the end the reactor was depressurized and the temperature was dropped to 30° C. The recovered polymer was dried at 70° C. under a nitrogen flow and weighted.

### Ethylene Homopolymerization: General Procedure.

A 4.5 liter stainless-steel autoclave equipped with a stirrer, temperature and pressure indicator, feeding line for hexane, ethylene, and hydrogen, was used and purified by fluxing pure nitrogen at 70° C. for 60 minutes. Then, 1550 cm³ of hexane containing 4.9 cm³ of 10% by wt/vol TEA/hexane solution (or equivalent amount of triisobutylaluminum), was introduced at a temperature of 30° C. under nitrogen flow. In a separate 200 cm³ round bottom glass bottle were successively introduced, 50 cm³ of anhydrous hexane, 1 cm³ of 10% by wt/vol, TEA/hexane solution (or equivalent amount of triisobutylaluminum) and about 0.010-0.025 g of the solid catalyst of table 2. They were mixed together, aged 10 minutes at room temperature and introduced under nitrogen flow into the reactor. The autoclave was closed, then the temperature was raised to 85° C., ethylene (7.0 bars partial pressure) and hydrogen (4 bar) were added.

Under continuous stirring, the total pressure was maintained at 85° C. for 120 minutes by feeding ethylene. At the end the reactor was depressurised and the temperature was dropped to 30° C. The recovered polymer was dried at 70° C. under a nitrogen flow.

### Example 1

The catalyst component was prepared according to the general procedure using 1-methyl pyrrole as compound (a). The characterization data and the results in the copolymerization of ethylene according to the general procedure, using 120 g of butene-1 in the polymerization bath, are given in table 1.

### Example 2

The same catalyst component as in example 1 was used in the ethylene homopolymerization according to the general procedure. The results are reported in Table 2.

### Example 3

The catalyst component was prepared according to the general procedure using pirrole as compound (a). The catalyst component was used in the ethylene homopolymerization according to the general procedure. The results are reported in Table 2.

### Comparative 1

The catalyst component was prepared according to the general procedure using 2,6-dimethylpyridine as compound (a). The catalyst component was used in the ethylene homopolymerization according to the general procedure. The results are reported in Table 2.

### Example 4

The catalyst component was prepared according to the general procedure using indole as compound (a). The catalyst component was used in the ethylene homopolymerization according to the general procedure using TIBA instead of TEAL and a polymerization temperature of 75° C. The results are reported in Table 2.

### Example 5

The catalyst component was prepared according to the general procedure using 1-methyl indole as compound (a). The characterization data and the results in the copolymerization of ethylene according to the general procedure, using 120 g of butene-1 in the polymerization bath, are given in table 1.

### Example 6

The catalyst component was prepared according to the general procedure using POCl₃ as compound (c) in an amount such as to give a molar ratio with Ti of 1.5. The characterization data and the results in the copolymerization of ethylene according to the general procedure, using 70 g of butene-1 in the polymerization bath, are given in table 1.

### Example 7

The catalyst component was prepared according to the general procedure using POCl₃ as compound (c). The catalyst component was used in the ethylene homopolymerization according to the general procedure. The results are reported in Table 2.

### Example 8

The catalyst component was prepared according to the general procedure using POCl₃ as compound (c). The characterization data and the results in the copolymerization of ethylene according to the general procedure, using 80 g of butene-1 in the polymerization bath, are given in table 1.

### Example 9

The catalyst component was prepared according to the general procedure using B(OMe)₃ as compound (b). The characterization data and the results in the copolymerization of ethylene according to the general procedure, using 180 g of butene-1 in the polymerization bath, are given in table 1.

### Example 10

The catalyst component was prepared according to the general procedure using BCl₃ as compound (b) in an amount such as to give a molar ratio with Ti of 1.3. The characterization data and the results in the copolymerization of ethylene according to the general procedure, using 100 g of butene-1 in the polymerization bath, are given in table 1.

### Example 11

The catalyst component was prepared according to the general procedure using B(OiPr)₃ as compound (b) in an amount such as to give a molar ratio with Ti of 1. The catalyst component was used in the ethylene homopolymerization according to the general procedure using TIBA instead of TEAL and a polymerization temperature of 75° C. The results are reported in Table 2.

TABLE 1

| | Catalyst | | | | | | | | |
|---|---|---|---|---|---|---|---|---|---|
| | Ti | | | Ethylene copolymerization | | | | | |
| | % | Mg | Time | Yield | C4 | XS | MIE | Dens | Tm |
| Ex | wt | % wt | Min | Kg/g_{cat} · h | % wt | % wt | g/10′ | g/cm³ | ° C. |
| 1 | 5.3 | 18.8 | 120 | 5.2 | 10.1 | 11.1 | 1.4 | 0.9217 | 125.2 |
| 5 | 5.2 | 19 | 120 | 4.6 | 7.3 | 3.1 | 0.5 | 0.9277 | 123.5 |
| 6 | 5 | 18.6 | 120 | 6.1 | 10.5 | 8.8 | 1.6 | 0.9258 | 125.1 |
| 8 | 4 | 18.4 | 83 | 6.2 | 6.4 | 4.7 | 0.66 | 0.9314 | 126.4 |
| 9 | 5.1 | 19.4 | 47 | 13.9 | 18.8 | 16.3 | 3.7 | <0.918 | 121.5 |
| 10 | 3.7 | 19.9 | 56 | 9.8 | 8.9 | 12.7 | 1.3 | 0.9233 | 125.2 |

TABLE 2

| | Catalyst | | Ethylene homopolymerization | | | |
|---|---|---|---|---|---|---|
| | Ti | Mg | Yield | MIE | | Bulk Dens. |
| Ex | % wt | % wt | Kg/g_{cat} | g/10′ | F/E | g/cm³ |
| 2 | 5.3 | 18.8 | 17 | 1.1 | 36.5 | 0.31 |
| 3 | 5.2 | 18.8 | 40 | 0.1< | — | 0.32 |
| Comp. 1 | 5 | 17.9 | 14.2 | 2.7 | 26 | 0.2 |
| 4 | 5.3 | 18.7 | 15 | 0.6 | 57.5 | 0.38 |
| 7 | 4.5 | 16.7 | 27.1 | 0.6 | 40.7 | 0.3 |
| 11 | 5 | 20 | 27.8 | 0.3 | 44.7 | 0.316 |

1. A solid catalyst component for the polymerization of olefins comprising Mg, Ti, halogen and at least one compound belonging to at least one of (a) aromatic heterocyclic nitrogen derivatives wherein at least one nitrogen atom is part of a five member ring structure, (b) boron derivatives of formula BR₃, and (c) phosphorous derivatives of formula PR₃ or POR₃, wherein R is, independently, a halogen, a hydrocarbyl group having from 1 to 20 carbon atoms or a hydrocarbyloxy group having up to 20 carbon atoms.

2. The solid catalyst component according to claim 1 which comprises the compound (a) selected from compounds with only a five member ring and compounds having a five member ring condensed with other rings.

3. The solid catalyst component according to claim 1 comprising boron derivatives (b) of formula BR₃ wherein R is selected from chlorine or hydrocarbyloxy group having up to 20 carbon atoms.

4. The solid catalyst component according to claim 1, comprising phosphorous derivatives (c) of formula PR₃ or POR₃ wherein R is selected from chlorine, hydrocarbyloxy group having up to 10 carbon atoms or alkyl groups having up to 10 carbon atoms.

5. The solid catalyst component according to claim 1 comprising in addition to the compound (a), (b) and/or (c), a Ti compound and a magnesium dihalide.

6. The solid catalyst component of claim 5 wherein the Ti compound is a titanium tetrahalide or a compound of formula TiXₙ(OR¹)₄₋ₙ, where 0≦n≦3, X is chlorine, and R¹ is C₁-C₁₀ hydrocarbon group.

7. A catalyst for the polymerization of olefins comprising the product obtained by contacting:
1) a solid catalyst component comprising Mg, Ti halogen and at least one compound belonging to at least one of (a) aromatic heterocyclic nitrogen derivatives wherein at least one nitrogen atom is part of a five member ring structure (b) boron derivatives of formula BR₃, and (c) phosphorous derivatives of formula PR₃ or POR₃, wherein R is, independently a halogen, a hydrocarbyl group having from 1 to 20 carbon atoms or a hydrocarbyloxy group having up to 20 carbon atoms.
2) at least one aluminum alkyl compound, and optionally
3) an external electron donor compound.

8. The catalyst according to claim 7, wherein the aluminum alkyl compound is the product obtained by mixing an Al trialkyl compound with an aluminumalkyl halide.

9. The catalyst according to claim 7, wherein the external electron donor compound is tetrahydrofurane.

10. A process for the (co)polymerization of olefins CH₂═CHR, wherein R is hydrogen or a hydrocarbon radical having 1-12 carbon atoms, comprising polymerizing olefins in the presence of a catalyst comprising the product obtained by contacting:
1) a solid catalyst component comprising Mg, Ti, halogen and at least one compound belonging to at least one of (a) aromatic heterocyclic nitrogen derivatives wherein at least one nitrogen atom is part of a five member ring structure, (b) boron derivatives of formula BR₃, and (c) phosphorous derivatives of formula PR₃, or POR₃ wherein R is, independently a halogen, a hydrocarbyl group having from 1 to 20 carbon atoms or a hydrocarbyloxy group having up to 20 carbon atoms,
2) at least one aluminum alkyl compound, and optionally
3) an external electron donor compound
